(19) United States
(12) Patent Application Publication
(10) Pub. No.: US 2015/0117400 A1
(43) Pub. Date: Apr. 30, 2015

(54) SIGNALING NETWORK CAPABILITIES FOR A WIRELESS DEVICE

(71) Applicant: QUALCOMM Incorporated, San Diego, CA (US)

(72) Inventors: Thawatt GOPAL, San Diego, CA (US); Krishna Rao MANDADAPU, San Diego, CA (US); Kiran PATIL, San Diego, CA (US); Nitin PANT, San Diego, CA (US); Tom CHIN, San Diego, CA (US)

(73) Assignee: QUALCOMM Incorporated, San Diego, CA (US)

(21) Appl. No.: 14/068,805

(22) Filed: Oct. 31, 2013

(51) Int. Cl. H04W 36/00

(52) U.S. Cl. CPC H04W 36/0083; H04W 36/0022
USPC 370/331

(57) ABSTRACT

When a user equipment is performing a packet-switched handover from a source radio access technology (RAT) to target RAT (such as Long Term Evolution) in connected mode, the UE may indicate a UTRA RAT capability based on an operator of the source RAT or an operator of the target RAT. If the operator is associated with a TD-SCDMA network, the UE may indicate a TD-SCDMA capability. If the operator is not associated with a TD-SCDMA network, the UE may indicate a W-CDMA capability.

### CROSS-REFERENCE TO RELATED APPLICATIONS

This application is related to U.S. patent application Ser. No. 13/842,629 entitled “APPARATUS AND METHOD FOR SIGNALING NETWORK CAPABILITIES FOR A WIRELESS DEVICE,” filed on Mar. 15, 2013, in the names of AMERGA, et al. which claims the benefit under 35 U.S.C. §119(e) to U.S. Provisional Patent Application No. 61/618,377 entitled “APPARATUS AND METHOD FOR SIGNALING NETWORK CAPABILITIES FOR A WIRELESS DEVICE,” filed on Mar. 30, 2012, in the names of AMERGA, et al., the disclosures of which are expressly incorporated by reference herein in their entireties.

### BACKGROUND

1. Field

Aspects of the present disclosure relate generally to wireless communication systems, and more particularly, to indicating network capabilities when connecting to a new radio access technology (RAT).

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

Offered is a method for wireless communication. The method includes performing handover from a source radio access technology (RAT) to a target RAT. The method also includes identifying an association between a user equipment (UE) and a network operator. The method further includes determining a UE capability to report to the target RAT. The UE capability includes a capability to communicate with a particular RAT associated with the network operator. The method still further includes reporting the determined UE capability to the target RAT.

Offered is an apparatus for wireless communication. The apparatus includes means for performing handover from a source radio access technology (RAT) to a target RAT. The apparatus also means for includes identifying an association between a user equipment (UE) and a network operator. The apparatus further includes means for determining a UE capability to report to the target RAT. The UE capability includes a capability to communicate with a particular RAT associated with the network operator. The apparatus still further includes means for reporting the determined UE capability to the target RAT.

Offered is a computer program product for wireless communication in a wireless network, comprising. The computer program produce includes a computer-readable medium having non-transitory program code recorded thereon. The program code includes program code to perform handover from a source radio access technology (RAT) to a target RAT. The program code also includes program code to identify an association between a user equipment (UE) and a network operator. The program code further includes program code to determine a UE capability to report to the target RAT. The UE capability includes a capability to communicate with a particular RAT associated with the network operator. The program code still further includes program code to report the determined UE capability to the target RAT.

Offered is an apparatus for wireless communication. The apparatus includes a memory and a processor(s) coupled to the memory. The processor(s) is configured to perform handover from a source radio access technology (RAT) to a target RAT. The processor(s) is also configured to identify an association between a user equipment (UE) and a network operator. The processor(s) is further configured to determine a UE capability to report to the target RAT. The UE capability includes a capability to communicate with a particular RAT associated with the network operator. The processor(s) is still further configured to report the determined UE capability to the target RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a call flow diagram illustrating signaling network capabilities according to one aspect of the present disclosure.

FIG. 5 is a block diagram illustrating a method for signaling network capabilities according to one aspect of the present disclosure.

FIG. 6 is a diagram illustrating an example of a hardware implementation for an apparatus employing a processing system according to one aspect of the present disclosure

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

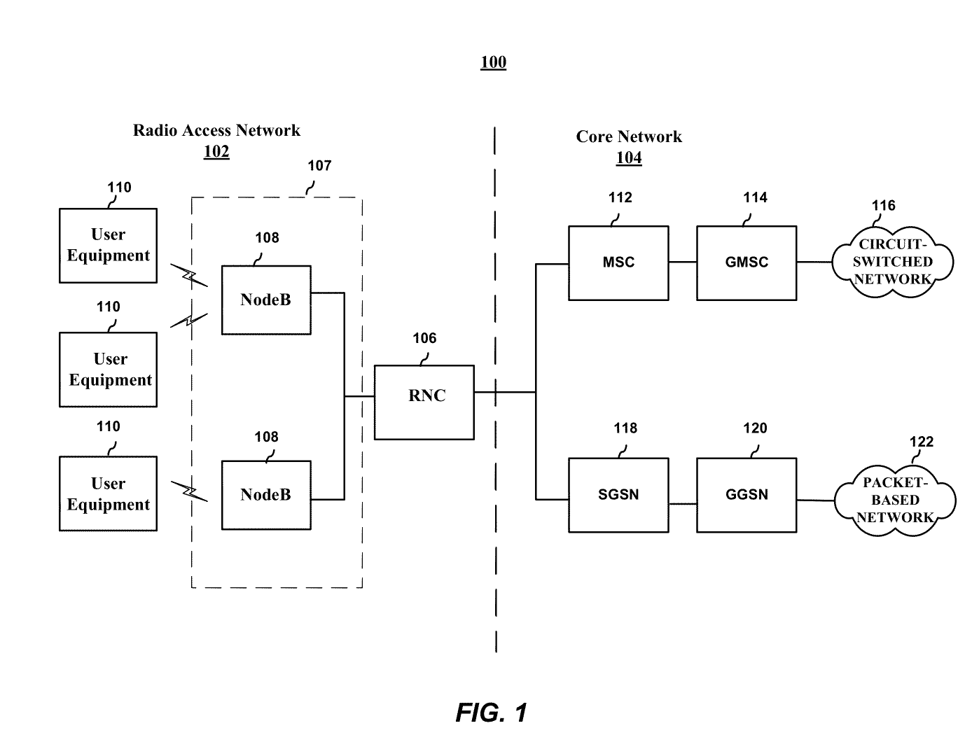

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

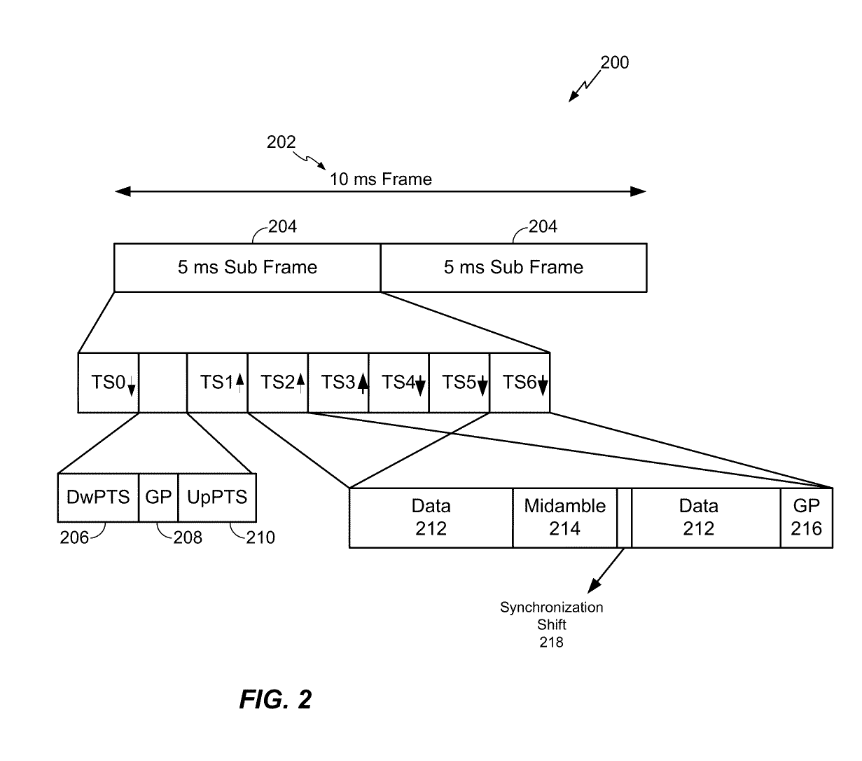

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

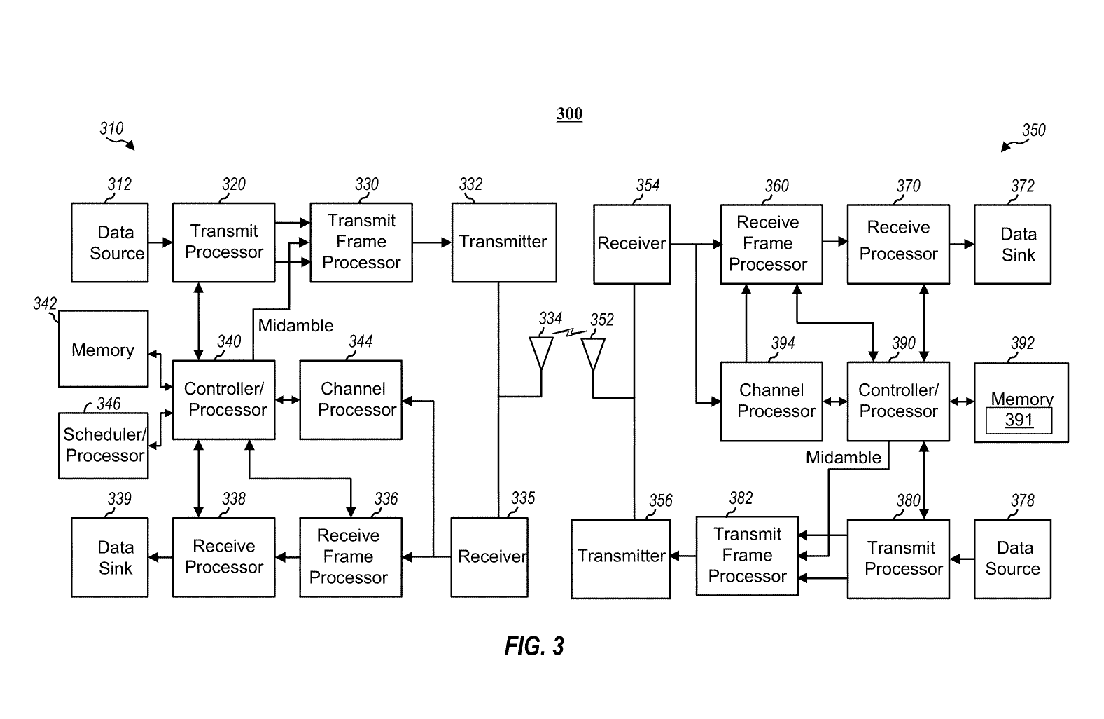

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a network capability module 391 which, when executed by the controller/processor 390, configures the UE 350 for maintaining frequency tracking loops. A scheduler/processor 346 at the node B 310 may be used to allocate resources to the UEs and schedule downlink and/or uplink transmissions for the UEs.

Signaling Network Capabilities for a Wireless Device

During connected mode packet-switched handover of a UE from a source network (such as a TD-SCDMA network) to a target network (such as an Long Term Evolution (LTE) network), the UE may receive a handover message from a base station commanding the UE to perform handover to an LTE cell. During handover, a source RAT is a RAT that the UE is handing over from (that is, the RAT the UE is communicating with prior to the handover) and a target RAT is a RAT the UE is handing over to (that is, the RAT the UE is communicating with following the handover). As part of the handover, the UE may communicate its capabilities to the LTE cell. The communicated capabilities may include the different networks the UE may be able to connect to so that the LTE cell may manage further UE handover and other behavior according to the UE's capabilities.

One issue with present LTE specifications arises when communicating the different radio access technologies (RATs) (i.e., networks) the UE may communicate with. Presently, during registration with the LTE network, such as during packet-switched handover while in connected mode, the LTE specifications do not allow the UE to simultaneously communicate the UE's ability to connect to a UTRA-TDD 1.28 Mcps RAT (i.e., a TD-SCDMA network) and the UE's ability to connect to a UTRA-FDD RAT (i.e., a W-CDMA network). That is, in responding to the command to communicate its capabilities the UE may either indicate one UTRA RAT (TD-SCDMA or W-CDMA) but not both. Thus, even if a UE is capable of communicating on both TD-SCDMA and W-CDMA the UE must choose only one UTRA RAT capability to communicate to the LTE network, resulting in ambiguous UTRA capability reporting.

Offered is a method to choose which UTRA RAT capability to report to the LTE network to improve UE operation. In one aspect, the UE may communicate the UTRA RAT capability based on a network operator associated with the LTE network or UTRA RAT. A network operator (also called a network carrier) is a network service provider to which a user subscribes for wireless service. Examples of operators include China Mobile, Verizon, AT&T, T-Mobile, etc. The UE may select a UTRA RAT based on which operator is affiliated with the UE and the UTRA RAT in an effort to avoid connecting the UE to a non-home network.

In one aspect, the UE may report a RAT capability to the LTE network based on which operator is associated with the LTE network and the UE. For example, once the UE enters connected mode with the LTE network the UE will read the Public Land Mobile Network (PLMN) identification (ID), which is located in system information block 1 (SIB-1). The UE may read SIB-1 in idle mode, or the UE may read SIB-1 in connected mode, such as when the UE hands over to a new cell in connected mode. The UE will then lookup, in a table stored on the UE, which operator is associated with the PLMN ID and whether the UE is associated with the operator (such as subscribing to the operator or subscribing to a network with a roaming agreement with the operator). Based on the operator, the UE may then determine which UTRA RAT (TD-SCDMA or W-CDMA) is associated with the operator. The UE will then select and report its ability to communicate on the particular UTRA RAT associated with the operator of the LTE network.

Under certain circumstances, however, such as during packet-switched handover in connected mode, the UE may receive a UE capability inquiry before the UE has been able to read the PLMN ID from SIB-1. In this circumstance, another solution to selecting the UTRA RAT to report may be implemented.

In one solution, the UE may identify an association between the UE and a network operator For example, the UE may check the PLMN ID for a source RAT during UE handover. The UE may then compare the source RAT PLMN ID with a lookup table to identify the operator of the source RAT, and then identify whether the UE has an association with the operator (such as subscribing to the operator or subscribing to a network with a roaming agreement with the operator). Then, the UE may lookup whether the source RAT operator operates a TD-SCDMA network. If so, the UE may indicate to the target LTE RAT that the UE has TD-SCDMA capability. If not, the UE may indicate to the target LTE RAT that the UE has W-CDMA capability.

In another solution, the UE may combine the first and second solution and check both the operator of the source RAT as well as an operator associated with the acquired LTE frequency. This may be useful when the UE connects to an LTE operator that may not necessarily be the home operator for the UE but may be a secondary operator that is somehow associated or affiliated with the home operator of the UE (such as through a roaming partner agreement or similar arrangement). Thus, the UE may report UTRA capabilities based on roaming partner arrangements between a UTRA operator and/or an operator of a source RAT or the target LTE RAT. The various lookup tables described above may be stored in a network capability module 391.

In yet another solution, if the UE is handing over from a UTRA RAT to the LTE network, the UE may simply communicate the ability to communicate with the source UTRA RAT to the LTE network.

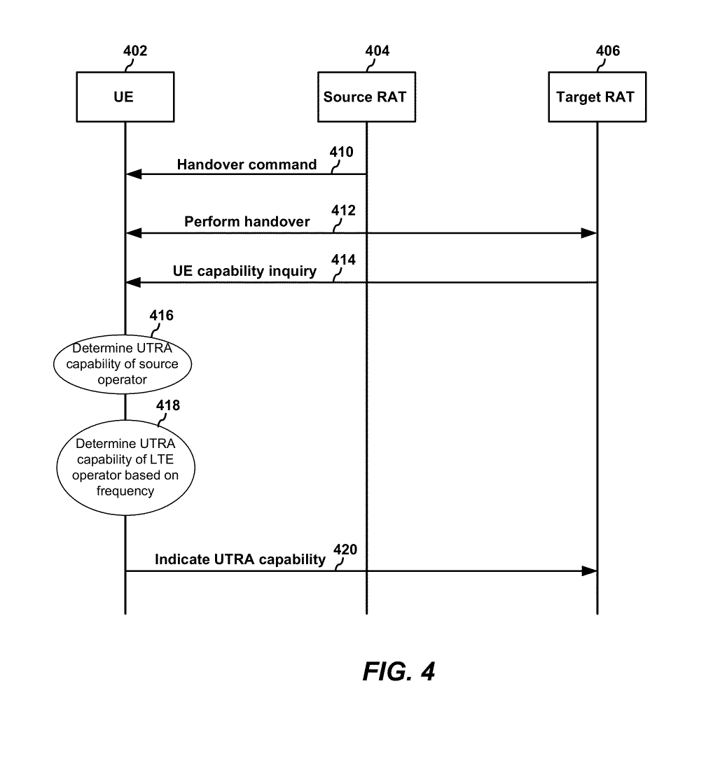

FIG. 4 illustrates a call flow diagram illustrating signaling network capabilities according to one aspect of the present disclosure. A UE 402 receives a handover command 410 from a source RAT 404. The UE 402 then performs handover 412 with a target RAT 406. The UE 402 receives a UTRA capability inquiry 414 from the target RAT 406. The UE 402 then may determine (416) the UTRA capability of the source RAT operator as described above. The UE 402 may also determine (418) the UTRA capability of the target RAT operator as described above. The UE 402 may then indicate its UTRA capability (420) to the target RAT 406 based on the above determinations. The UE 402 may also choose to indicate the UTRA that is the same as the source RAT.

Although, the above solutions may assist when a UE has not yet acquired an LTE PLMN ID in a SIB-1 message, they may be performed regardless of the UE's acquiring of the LTE PLMN ID in the SIB-1 message.

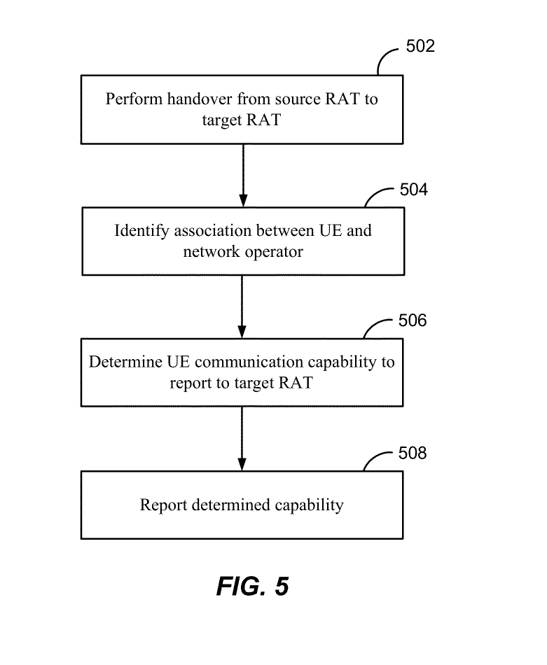

FIG. 5 shows a wireless communication method according to one aspect of the disclosure. A UE may perform handover from a source RAT to a target RAT, as shown in block 502. The UE may identify an association between a user equipment (UE) and a network operator, as shown in block 506. The UE may also determine a UE capability, as shown in block 506. The UE capability may be a capability to communicate with a particular RAT. The particular RAT may be associated with a network operator. The UE may also report the determined capability to the target RAT, as shown in block 508.

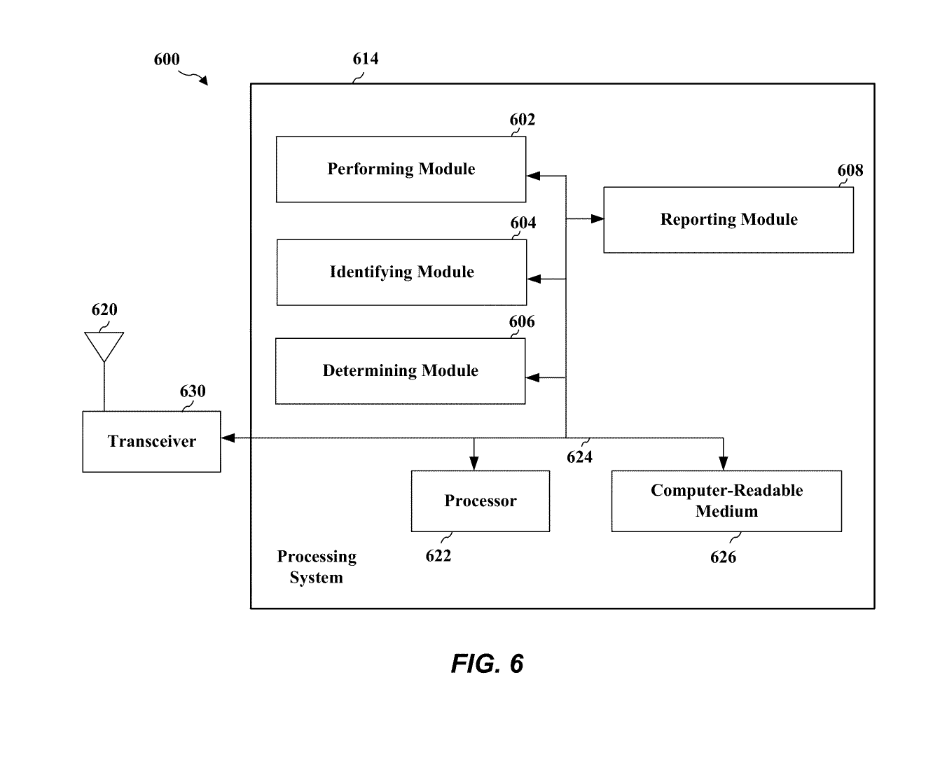

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622, the modules 602-608, and the computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a performing module 602 for performing handover from a source RAT to a target RAT. The processing system 614 also includes an identifying module 604 for identifying an association between a UE and a network operator. The processing system 614 also includes a determining module 606 for determining a UE capability to report to the target RAT. The processing system 614 further includes reporting module 608 for reporting the determined capability to the target RAT. The modules may be software module(s) running in the processor 622, resident/stored in the computer-readable medium 626, one or more hardware modules coupled to the processor 622, or some combination thereof. The processing system 614 may be a component of the UE 350 and may include the memory 392, and/or the controller/processor 390.

In one configuration, an apparatus such as a UE is configured for wireless communication including means for determining a UE capability. In one aspect, the above means may be the controller/processor 390, the memory 392, antenna 352, receive processor 370, transmit processor 380, receiver 354, transmitter 356, performing module 602, and/or the processing system 614 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for identifying an association between a UE and an operator. In one aspect, the above means may be the controller/processor 390, the memory 392, a network capability module 391, identifying module 604, and/or the processing system 614 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for determining a UE capability. In one aspect, the above means may be the controller/processor 390, the memory 392, a network capability module 391, determining module 606, and/or the processing system 614 configured to perform the functions recited by the aforementioned means. In another aspect, the aforementioned means may be a module or any apparatus configured to perform the functions recited by the aforementioned means.

In one configuration, an apparatus such as a UE is configured for wireless communication including means for reporting. In one aspect, the above means may be the controller/processor 390, the memory 392, the transmitter 356, the antenna 352, a network capability module 391, reporting module 608, and/or the processing system 614 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
performing handover from a source radio access technology (RAT) to a target RAT;
identifying an association between a user equipment (UE) and a network operator;
determining a UE capability to report to the target RAT, the UE capability comprising a capability to communicate with a particular RAT associated with the network operator; and
reporting the determined UE capability to the target RAT.

2. The method of claim 1, in which the determining is based at least in part on an acquired target frequency band and the network operator is associated with the acquired target frequency band.

3. The method of claim 1, in which the determining is based at least in part on a network identifier of the source RAT and the network operator is associated with the network identifier.

4. The method of claim 1, in which the particular RAT is the source RAT.

5. The method of claim 1, in which the determining is based at least in part on an acquired target frequency band and the network operator is associated with the acquired target frequency band and in which one of:
the determining is further based at least in part on a network identifier of the source RAT and the network operator is associated with the network identifier, or
the particular RAT is the source RAT.

6. The method of claim 1, in which the target RAT is Long Term Evolution (LTE).

7. An apparatus for wireless communication, comprising:
means for performing handover from a source radio access technology (RAT) to a target RAT;
means for identifying an association between a user equipment (UE) and a network operator;
means for determining a UE capability to report to the target RAT, the UE capability comprising a capability to communicate with a particular RAT associated with the network operator; and
means for reporting the determined UE capability to the target RAT.

8. The apparatus of claim 7, in which the means for determining is based at least in part on an acquired target frequency band and the network operator is associated with the acquired target frequency band.

9. The apparatus of claim 7, in which the means for determining is based at least in part on a network identifier of the source RAT and the network operator is associated with the network identifier.

10. The apparatus of claim 7, in which the particular RAT is the source RAT.

11. The apparatus of claim 7, in which the means for determining is based at least in part on an acquired target frequency band and the network operator is associated with the acquired target frequency band and in which one of:
the means for determining is further based at least in part on a network identifier of the source RAT and the network operator is associated with the network identifier, or
the particular RAT is the source RAT.

12. A computer program product for wireless communication in a wireless network, comprising:
a computer-readable medium having non-transitory program code recorded thereon, the program code comprising:
program code to perform handover from a source radio access technology (RAT) to a target RAT;
program code to identify an association between a user equipment (UE) and a network operator;
program code to determine a UE capability to report to the target RAT, the UE capability comprising a capability to communicate with a particular RAT associated with the network operator; and
program code to report the determined UE capability to the target RAT.

13. The computer program product of claim 12, in which the program code to determine is based at least in part on an acquired target frequency band and the network operator is associated with the acquired target frequency band.

14. The computer program product of claim 12, in which the program code to determine is based at least in part on a network identifier of the source RAT and the network operator is associated with the network identifier.

15. The computer program product of claim 12, in which the particular RAT is the source RAT.

16. The computer program product of claim 12, in which the program code to determine is based at least in part on an acquired target frequency band and the network operator is associated with the acquired target frequency band and in which one of:
the program code to determine is further based at least in part on a network identifier of the source RAT and the network operator is associated with the network identifier, or
the particular RAT is the source RAT.

17. An apparatus for wireless communication, comprising:
a memory; and
at least one processor coupled to the memory and configured:
to perform handover from a source radio access technology (RAT) to a target RAT;
to identify an association between a user equipment (UE) and a network operator;
to determine a UE capability to report to the target RAT, the UE capability comprising a capability to communicate with a particular RAT associated with the network operator; and
to report the determined UE capability to the target RAT.

18. The apparatus of claim 17, in which the at least one processor is configured to determine is based at least in part on an acquired target frequency band and the network operator is associated with the acquired target frequency band.

19. The apparatus of claim 17, in which the at least one processor is configured to determine is based at least in part on a network identifier of the source RAT and the network operator is associated with the network identifier.

20. The apparatus of claim 17, in which the particular RAT is the source RAT.

21. The apparatus of claim 17, in which the at least one processor is configured to determine is based at least in part on an acquired target frequency band and the network operator is associated with the acquired target frequency band and in which one of:
the at least one processor is configured to determine further based at least in part on a network identifier of the source RAT and the network operator is associated with the network identifier, or
the particular RAT is the source RAT.

22. The apparatus of claim 17, in which the target RAT is Long Term Evolution (LTE).
